(19) United States
(12) Patent Application Publication
(10) Pub. No.: US 2013/0167048 A1
(43) Pub. Date: Jun. 27, 2013

(54) CONTEXT DEPENDENT PERSONALIZATION OF REUSE COMPONENTS FOR A USER INTERFACE

(71) Applicants: Markus Viol, Walldorf (DE); Franz Muller, Stutensee (DE); Markus Ofterdinger, Leimen (DE); Carsten Brandt, Mannheim (DE); Stefan Haffner, Hockenheim (DE); Felix Riegger, Mannheim (DE); Thomas Gieselmann, Weinheim (DE)

(72) Inventors: Markus Viol, Walldorf (DE); Franz Muller, Stutensee (DE); Markus Ofterdinger, Leimen (DE); Carsten Brandt, Mannheim (DE); Stefan Haffner, Hockenheim (DE); Felix Riegger, Mannheim (DE); Thomas Gieselmann, Weinheim (DE)

(21) Appl. No.: 13/336,706

(22) Filed: Dec. 23, 2011

(51) Int. Cl. G06F 3/01

(52) U.S. Cl. 715/762

(57) ABSTRACT

According to some embodiments, a business service provider may associate a user interface floor plan with a plurality of reuse components, each reuse component being adapted to be used with multiple user interface floor plans. For example, a second reuse component may be embedded within a first reuse component. In this case, an end user adaptation to the second reuse component may be received and the system may automatically store, within the first reuse component, a context dependent reference to the second reuse component associated with the end user adaptation.

### FIELD

Some embodiments relate to a service-oriented architecture associated with business objects. More specifically, some embodiments provide context dependent personalization of reuse components for user interface (e.g., to support life cycle extensions in connection with a service-oriented architecture).

### BACKGROUND

An enterprise may store and access business information in a number of different ways. For example, an enterprise might store a substantial amount of information about products, sales, human resources, etc. in one or more database structures created by a business service provider (e.g., SAP AG® or SalesForce®). The enterprise might also generate various views of that information as needed (e.g., to create financial reports). In some cases, the enterprise might use pre-defined user interfaces to interact with the database structures. Often, however, an enterprise will want to personalize or customize these user interfaces based on the business needs of the enterprise. For example, an enterprise might change a sales order user interface by adding a “Sub Product Identifier” next to an existing “Product Identifier.”

In some cases, a user interface may be constructed with “reuse” components that are used for many different user interfaces. For example, a “Purchase Order” reuse component might be found on hundreds of different user interfaces. Note that the use of reuse components may be transparent to a user who personalizes and/or changes his or her screen display. That is, the reuse nature of such components might not be visible to the user and personalization of the components may be applied only to the context in which the personalization was done (and not on the reuse component itself). For example, if a user changes a Purchase Order component on one user interface, it may not be changed on other interfaces that use the same component.

Further note that a business service provider may periodically make changes to database structures and user interfaces. For example, the business service provider might release system wide patches or new versions of various database structures and interfaces to improve the efficiency of the system or to add new features. Unfortunately, these changes might conflict with previous customizations made by an enterprise. It can be difficult, therefore, to provide stability for personalizations made to reuse components over several releases (e.g., when the usages and the reuse components may change) especially when a substantial number of reuse components and/or customizations are involved.

Accordingly, a method and mechanism to efficiently allow customizations to a user interface, including reuse components, may be provided by some embodiments herein.

### BRIEF DESCRIPTION OF THE DRAWINGS

FIG. 1 is a block diagram of a system according to some embodiments.

FIG. 2 illustrates a user interface floor plan with reuse components in accordance with some embodiments.

FIG. 3 is an example of a user interface.

FIG. 4 is a flow diagram of a process according to some embodiments.

FIG. 5 illustrates a user interface floor plan with reuse components having an embedding anchor in accordance with some embodiments.

FIG. 6 illustrates an insertion of a reuse component in accordance with some embodiments.

FIG. 7 illustrates a deletion of a reuse component in accordance with some embodiments.

FIG. 8 illustrates a replacement of a reuse component in accordance with some embodiments.

FIG. 9 is a block diagram of a system wherein a key user tool creates metadata according to some embodiments.

FIG. 10 illustrates an XML representation of a floor plan in accordance with some embodiments.

FIG. 11 is a block diagram of a platform in accordance with some embodiments.

### DETAILED DESCRIPTION

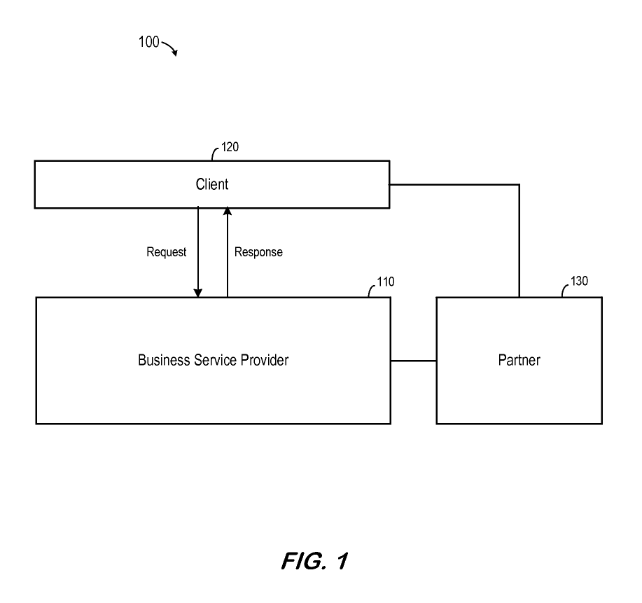

An enterprise might store and access business information in a number of different ways. For example, an enterprise might store a substantial amount of information about products, sales, human resources, etc. in one or more database structures created by a business service provider (e.g., SAP AG® or SalesForce®). FIG. 1 is a block diagram of a system 100 according to some embodiments. In this case, a business service provider 110 might host and provide business services for a client 120. For example, the business service provider 110 might receive requests from the client 120 and provide responses to the client 120 via a service-oriented architecture such as those provided by SAP Business ByDesign® or Salesforce®. The use of the remotely hosted business process platform may help the client 120 avoid the costs and problems associated with maintaining a local, “in house” Enterprise Resource Planning (ERP) system.

The client 120 may be associated with a Web browser to access services provided by business process platform 110 via HyperText Transport Protocol (HTTP) communication. For example, a user may manipulate a user interface of the client 120 to input an instruction (e.g., “show me a sales report”). The client 120, in response, may transmit a corresponding HTTP service request to the business service provider 110 as illustrated. A service-oriented architecture may conduct any processing required by the request (e.g., generating views and user interfaces) and, after completing the processing, provide a response to client 120. The client 120 might comprise a Personal Computer (PC) or mobile device executing a Web client. Examples of a Web client include, but are not limited to, a Web browser, an execution engine (e.g., JAVA, Flash, Silverlight) to execute associated code in a Web browser, and/or a dedicated standalone application.

Note that FIG. 1 represents a logical architecture for describing processes according to some embodiments, and actual implementations may include more or different components arranged in other manners. Moreover, each system described herein may be implemented by any number of devices in communication via any number of other public and/or private networks. Two or more of devices of may be located remote from one another and may communicate with one another via any known manner of network(s) and/or a dedicated connection. Moreover, each device may comprise any number of hardware and/or software elements suitable to provide the functions described herein as well as any other functions. Other topologies may be used in conjunction with other embodiments.

All systems and processes discussed herein may be embodied in program code stored on one or more computer-readable media. Such media may include, for example, a floppy disk, a CD-ROM, a DVD-ROM, a Zip® disk, magnetic tape, and solid state Random Access Memory (RAM) or Read Only Memory (ROM) storage units. Embodiments are therefore not limited to any specific combination of hardware and software.

The business service provider 110 might store client information into and retrieve client information from one or more database structures, such one or more “business objects.” As used herein, the phrase “business object” may refer to a set of entities with common characteristics and common behavior representing a defined business semantic. Note that business data may be stored within physical tables of a database. The database may comprise a relational database such as SAP MaxDB, Oracle, Microsoft SQL Server, IBM DB2, Teradata and the like. Alternatively, the database could be a multi-dimensional database, an eXtendable Markup Language (XML) document, or any other structured data storage system. The physical tables may be distributed among several relational databases, dimensional databases, and/or other data sources.

The structures of and relationships between the physical database tables may be complex, and business objects may be used to shield developers and end-users from these complexities. A business object may comprise, for example, a software model including nodes to encapsulate related data and methods. Moreover, a business object may be associated with a business entity, such as a customer, partner, sales order, product, store, time, etc., represented in the data of a data source. Each instance of a business object may represent a particular instance of the entity represented by the business object. An instance of a sales order business object may, for example, provide a mapping to the underlying tables storing data associated with a particular sales order.

In general terms, the business object model defines business-related concepts for a number of business transactions. The business object model may reflect the decisions and relationships about real world businesses acting in business transactions and may span across different industries and business areas. The business object model may be, for example, defined by business objects and their relationships to each other. Despite being applicable across different business entities and industries, business object model interfaces may be consistent across the different industries and across different business units because they are generated using a single business object model.

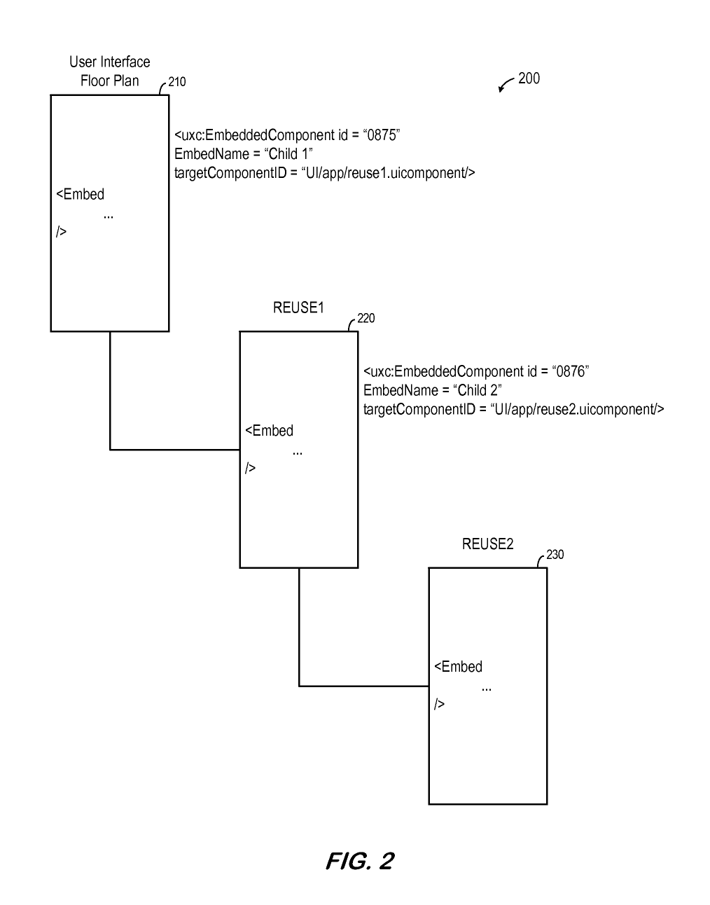

The client 120 might use pre-defined user interfaces to interact with the database structures hosted by the business service provider 110. According to some embodiments, a user interface may be defined using an overall “floor plan” and may include one or more reuse components. For example, FIG. 2 illustrates an example 200 where an overall user interface floor plan 210 includes a first embedded reuse component 220 (“REUSE1”) embedded within that floor plan 210. The first embedded reuse component 220 might be associated with, for example, a name and address display element that appears in many different floor plans. In the example 200 of FIG. 2, note that a second reuse component 230 (“REUSE2”) is embedded within the first reuse component 220. According to some embodiments, the reuse components 220, 230 may be customized or personalized by an end user.

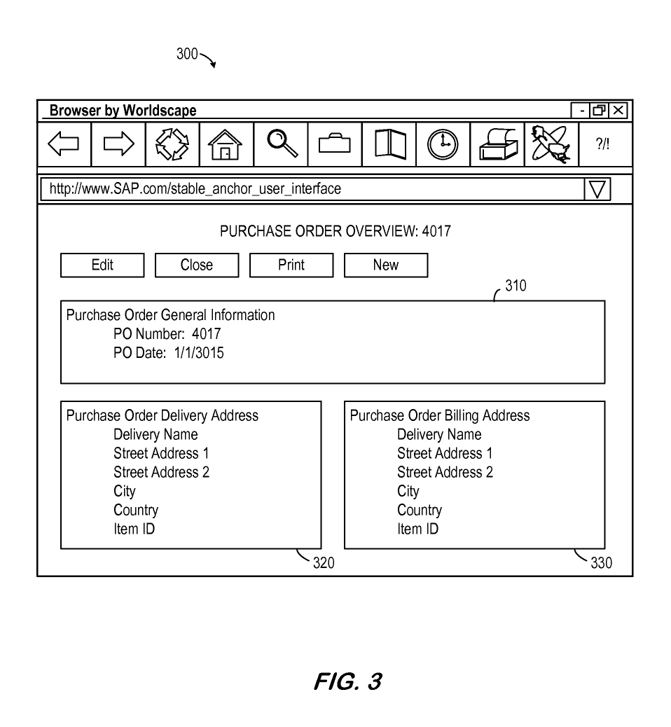

For example, FIG. 3 is an example of a purchase order user interface 300 including general information 310, a delivery address 320, and a billing address 330. Moreover, the delivery address 320 and billing address 330 may be implemented using reuse components embedded with the floor plan of the user interface 300. In some cases, the client 120 may want to customize such a user interface 300. For example, the client 120 might want to add a telephone number to the delivery address 320. According to some embodiments, a partner 130 of a business service provider 110 may also create and/or customize user interfaces for clients 120.

Note that the business service provider 110 may periodically make changes to the database structures such as business objects. For example, the business service provider 110 might release system wide patches or new versions of business objects and/or user interfaces to improve the efficiency of the system or to add new features.

Referring again to FIG. 2, according to some embodiments, an embedded component may be referenced in a host floor plan via an XML element entitled EmbeddedComponent. Moreover, the XML element may define a target component, a technical name of the location of the embedded component file in a repository, and/or a name associated with the embedding. A unique name for the embedding may be provided (e.g., because the same embedded component might appear several times on a single user interface). For example, an embedded component named “address” might appear twice in the display 300 of FIG. 3 (once for a delivery address and once for a billing address).

As illustrated in FIG. 2, it is possible to have a chain of embedded components 220, 230. That is, the host floor plan 210 may embed the first embedded reuse component 220 which itself embeds the second embedded reuse component 230. In the example of FIG. 2, the embed name for REUSE1 is “Child1” and the embed name of REUSE2 is “Child2.” Each time an embedded component is changed (for example REUSE1 may be deleted and re-inserted), a user interface designer may introduce a new embed name for the target component.

According to some embodiments, a user (e.g., an end user or key user) may personalize a screen in a “what you see is what you get” fashion. However, the user interface at runtime may not reflect which portions of the interface are associated with embedded reuse components are which portions are not associated with reuse components. When a user changes a component he or she may not expect that change to appear in other portions of the user interface (or even on an entirely different user interface). Thus, the personalization may be stored in connection with the embedded component (instead of the original reuse component).

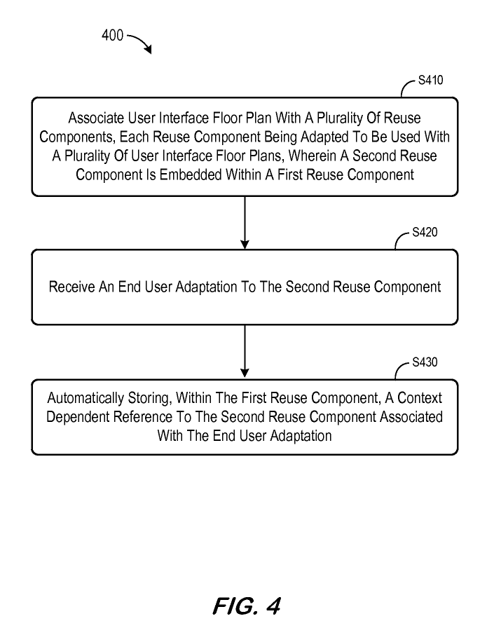

Thus, some embodiments described herein provide a context-dependent personalization of embedded components. For example, FIG. 4 is a flow diagram of a process 400 according to some embodiments. The business service provider 110 and/or client 120 may execute portions of the process 400 as will be described below, but embodiments are not limited thereto. In this regard, all processes described herein may be executed by any combination of hardware and/or software. The processes may be embodied in program code stored on a tangible medium and executable by a computer to provide the functions described herein. Further note that the flow charts described herein do not imply a fixed order to the steps, and embodiments of the present invention may be practiced in any order that is practicable.

At S410, a user interface floor plan may be associated with a plurality of reuse components, each reuse component being adapted to be used with a plurality of user interface floor plans, wherein a second reuse component is embedded within a first reuse component. At S420, an end user adaptation to the second reuse component may be received. For example, the end user might have moved an element or otherwise altered information that is displayed within the user interface in connection with the second reuse component.

At S430, a context dependent reference to the second reuse component may be automatically stored within the first reuse component. The reference may include, for example, a component identifier, name and/or file path. According to some embodiments, a reference comprises a stable embedding anchor that includes a reference to a software version number. Moreover, the file path associated with a reference might comprise, according to some embodiments, a chain of file paths associated with a plurality of embedding anchors associated with embedded reuse components.

In this way, a context dependant personalization of embedded components may be provided such that the system stored not only the information about the change (what has been personalized) but also information about the context associated with the component. The context may, for example, hold information about a host embedding chain. In the example 200 of FIG. 2, the personalization of the REUSE2 embedded component 230 may have the context information for REUSE1 component 220 plus the user interface floor plan 210. This context may be kept stable over multiple releases to help ensure that when a customer receives a new release his or her personalizations are still applied appropriately.

According to some embodiments, stability for personalizations may be provided using stable “anchors.” These anchors may exist, for example, on a section or a list on the user interface and may help ensure that data is not deleted by the application in a future release. Note, however, that the stability criteria may not be the same as where the personalization takes place. That is, the context (host chain for the embedding) in which the personalization was done may need to be maintained. Therefore, according to some embodiments described herein, a new type of stable anchor may be introduced to identify the usage of an embedded component in the hosting/parent component. This stable anchor might not be changed when an application changes the user interface in a future release. The stable anchor may, according to some embodiments, be moved to other usages of embedded component to help keep the personalization which was done by a user to any new usages.

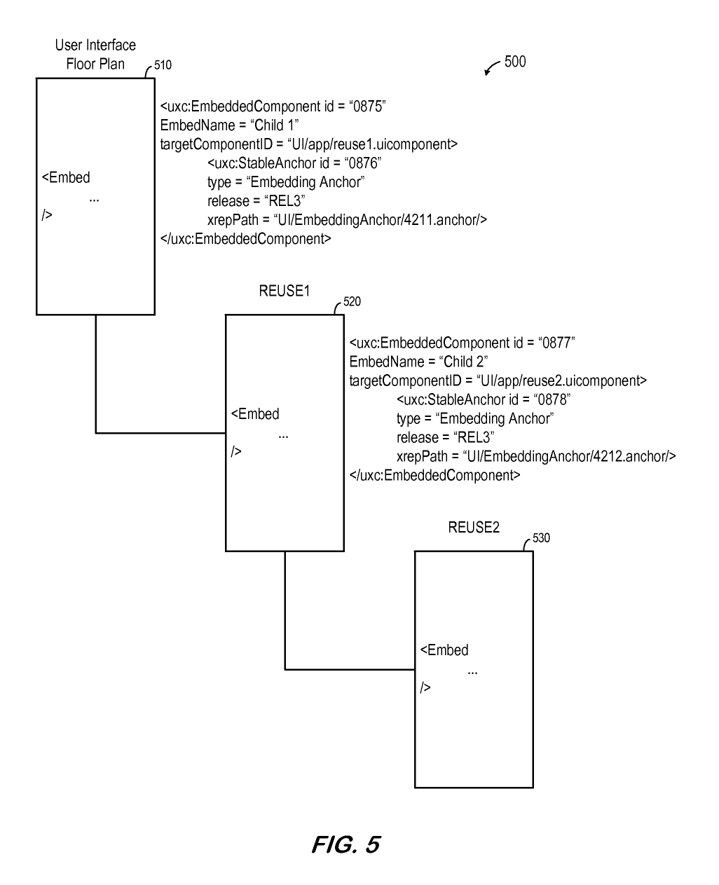

For example, FIG. 5 illustrates an example 500 where an overall user interface floor plan 510 includes a first embedded reuse component 520 (“REUSE1”) embedded within that floor plan 510. The first embedded reuse component 520 might be associated with, for example, a name and address display element that appears in many different floor plans. In the example 500 of FIG. 5, note that a second reuse component 530 (“REUSE2”) is embedded within the first reuse component 520. According to some embodiments, the reuse components 520, 530 may be customized or personalized by an end user.

According to some embodiments, the context for a usage might not be directly concatenated via a user interface file (associated with the floor plan 510, REUSE1, and REUSE2), and may instead be constructed via the embedding anchors in the files. That is, in the example 500 of FIG. 5, the context of REUSE2 may be in the embedding stable anchor of REUSE1 (where REUSE2 is embedded) plus the embedding stable anchor of the floor plan 510 (where REUSE1 is embedded). Thus, if REUSE1 were to be replaced with an entirely new component, the embedded information can simply be copied from REUSE1 to the new component.

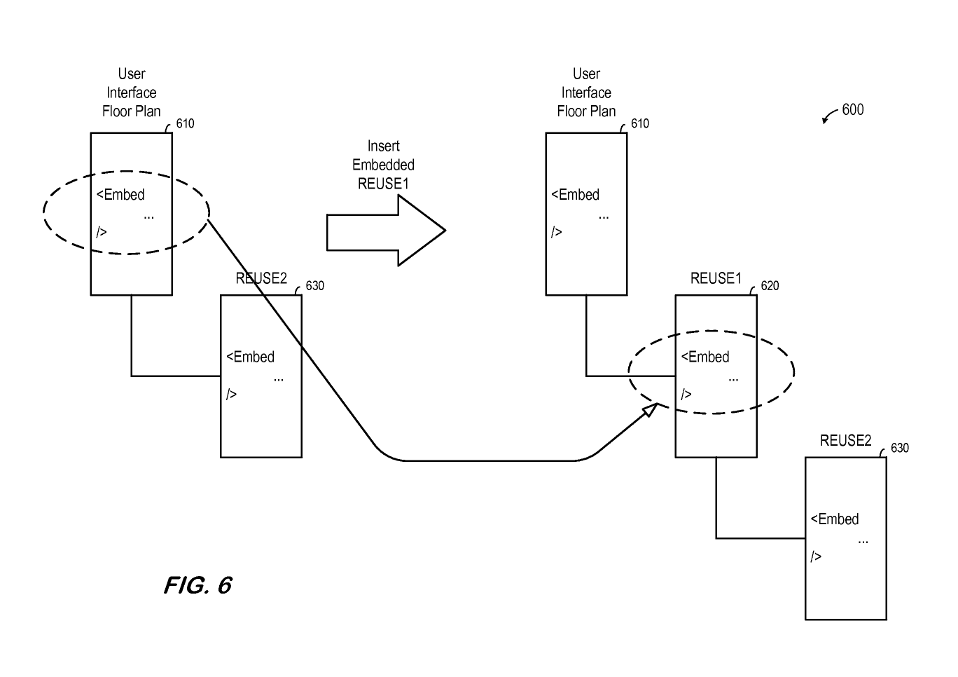

Now consider the example 600 of FIG. 6 where a floor plan 610 originally includes a reference to a single embedded component REUSE2 630. A new component REUSE1 620 is then inserted in an embedded fashion between the floor plan 610 and REUSE2 630. In this case, the embedded information originally contained in the floor plan 610 can simply be moved to the new REUSE1 620. That is, when an embedded component is inserted inside a chain of embedded reuse components, it may set a context attribute with the context information of the parent after the insertion. As a result, the child of the newly inserted component still receives the prior context of the old parent (before the insertion).

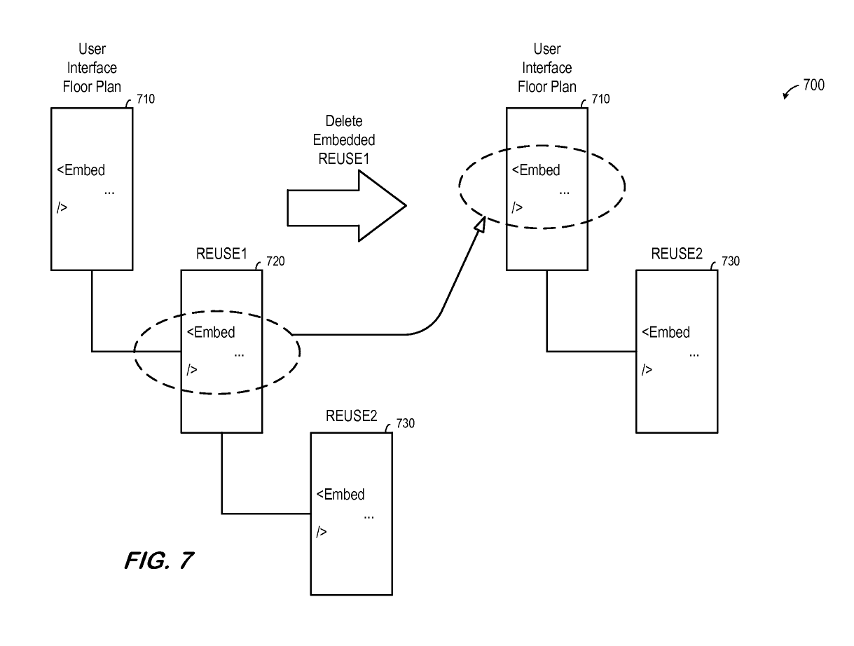

If an embedded component within a chain is deleted (instead of being inserted), the parent may fill its context attribute with the context of the deleted one. For example, FIG. 7 illustrates an example 700 where a floor plan 710 originally includes REUSE2 730 embedded with REUSE1 720. In this case, however, REUSE1 720 is to be deleted. To handle this situation, the child of the deleted component may still receive the former context of the deleted parent. That is, the context information may be moved from REUSE1 720 to the floor plan 710 as illustrated in FIG. 7. Since the cardinality between an embedding anchor and a usage may be 1-to-1, more than one embedding anchor inside an EmbeddingComponent element of the host component might not be permitted. As a result, if an embedding anchor moves from one EmbeddingComponent element (usage) to another, the moved embedding anchor may override an existing embedding anchor. If the existing embedding anchor is already released (note that a stable anchor might have a release attribute that can be checked to determine if the stable anchor is already in use on the client side), then the move of the embedding anchor might not be committed (this might be performed, for example, by an anchor provider).

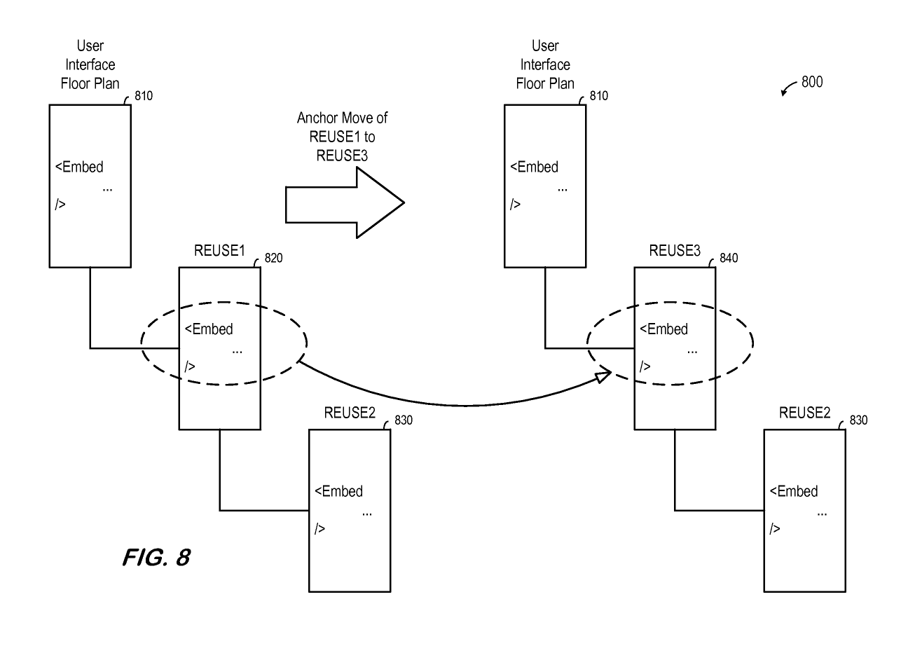

Thus, according to some embodiments, an application may exchange a component REUSE1 with a new one, and automatically move the embedding stable anchor where REUSE2 was embedded from REUSE1 to the new embedded component and any personalization that was done by the user will still be applied to REUSE2 in this context. Consider FIG. 8 which illustrates an example 800 wherein a floor plan 810 includes REUSE1 820 and REUSE2 830. In this case, REUSE1 820 is to be replaced with a new component (REUSE3 840). The embedding anchor from REUSE1 820 may then be copied to the new component REUSE3 840.

According to some embodiments, reuse components and/or user customizations might be associated with a repository provided at a business service provider backend system. The repository might, for example, replace a generic (XML based) diff/merge mechanism with a mechanism of explicitly modeled “change records” that are applied to a user interface reuse component by a plugin that understands how to deal with specific kinds of changes. Furthermore, a tool that creates these changes (e.g., user interface runtime authoring or user interface designer) might store and access these changes in the repository. The repository might furthermore realize which changes have to be applied to the base XML (and in what order) and call the appropriate plugin to apply the changes after an upgrade/change to the system.

Furthermore, the repository may provide a mechanism to handle stable and embedding anchors and use these anchors as a reference for change records to help ensure that the system collects all the change records that need to be applied to a user interface component, even when anchors are moved to a new user interface component. Since these mechanisms might not run always at runtime, a load for a user interface component might be created with all of the changes that should be applied for a client. To handle this efficiently, key user adaptations might be stored as a special list of change records that can be applied directly on a client via the user interface runtime. End user personalization change records may also be handled by the repository.

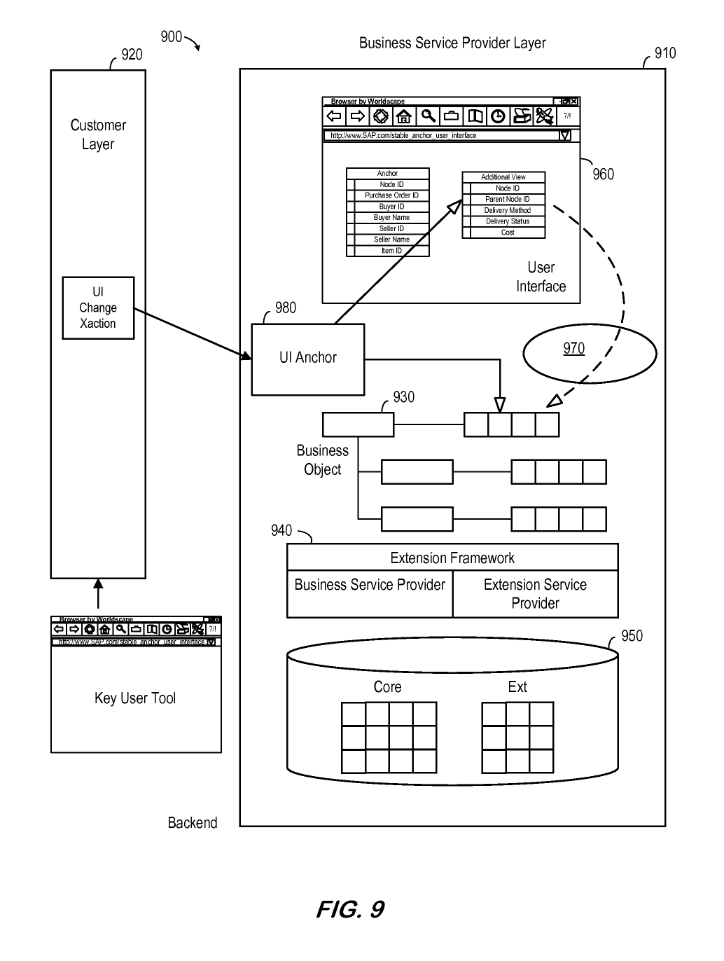

The handling of user interface anchors may be performed in a number of different ways. For example, FIG. 9 is a block diagram of a system 900 wherein a business services provider layer 910 (e.g., backend) interacts with a customer layer 920. The provider layer 910 includes a business object 930 and extension framework 940 between the business object 930 and core/extension information stored in a database 950. A user interface 960 may access the business object 930 via an access mechanism 970. The access mechanism 970 could be associated with, for example, (i) a Frontend Service Adaptation (FSA), (ii) a Controller Object (CO) implementation, (iii) a Business Service Architecture (BSA), (iv) an ABAP platform, (v) a Dynamic Dictionary (DDIC), (vi) manual coding, (vii) a Fast Search Infrastructure (FSA), (viii) a Transformed Object (TO), or (ix) a Transformation Node (TN). According to this embodiment, the provider layer 610 further includes a user interface anchor 980. The user interface anchor 980 might comprise, for example, a new entity with a new name representing a position in a user interface (e.g., a specific section). The new entity may have a name which is independent of a technical name of the user interface model. Thus, it may be kept stable, and this can be used as a stable anchor point. In other words: the new entity might be regarded as a part of the public model with respect to life cycle issues. According to some embodiments, the user interface anchor 980 comprises a stable anchor identifier, a type of “embedding anchor,” a software application version number, and a file path.

As used herein, the term “embedding anchor” may refer to a context-dependent personalization of reuse components. Note that components which are reusable may have a specific addition/change depending on usage (not on the component itself), and these components may themselves have other components that also depend on usage. When these additions/changes to the components are usage specific, and each host of a component can't be kept stable over software releases, an entity that is part of the reference from the host to the reusable component may be introduced. This entity may, for example, be moved to another host by still identifying the usage, but the host could be a new component (because in the new release the host component may have been replaced by a new version). Moreover, the entity which identifies the usage may need to have context information that can be used to identify the chain of usages even when parts of the chain are exchanged in the future.

According to some embodiments, a component name, such as a path of the user interface file will not be critical for the user interface at run time. Instead, the embedding context will be included each time a client requests a user interface model from a business service provider backend system. A repository may also store its files in a load depending on the context. Moreover, a change transaction dispatcher may get the current context from the repository and will distinguish between change transactions to determine whether or not a merge will be performed. A user interface run time model cache and a resource cache may also store user interface files depending on the context. According to some embodiments, the user interface backend cache (load) may also use the context instead of a parent component. Since the context will be part of the change transaction itself, it may need to be stable over releases. As a result, the stable anchor may be used to keep the embedding context stable over different release versions.

According to some embodiments, a context associated with a reuse component may take the form of: “@+repository path of the embedding anchor” (which may be a chain of references). In some cases, the context may be added as an attribute to the repository change transaction file (e.g., as a hash value) and the context might not be changeable once it is created. Note that load regeneration might only be done via a user interface request (and not via a change of the embedded component but instead via a change of the host component).

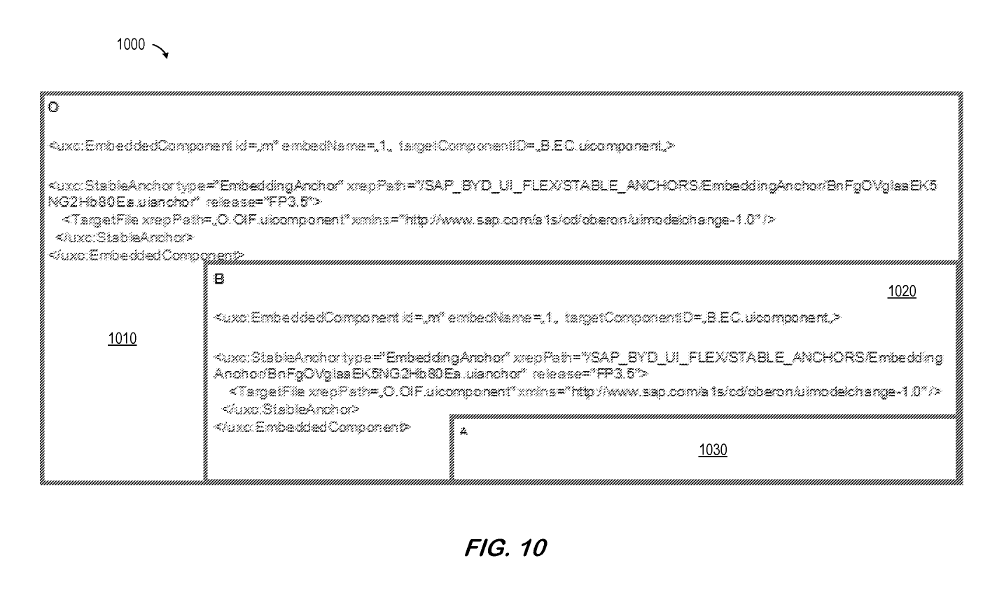

Consider now FIG. 10, which illustrates 1000 an XML representation of a floor plan ◯ 1010 in accordance with some embodiments. Note that the context of an embedded component may represent the repository path of the embedding anchor in the host component recursively. For example, embedded component A 1030 is embedded in embedded component B 1020, and embedded component B 1020 is embedded in the floor plan ◯ 1010. In this example, the context of A would be “@+(repository path of embedding anchor of component B 1020)+@+(repository path of embedding anchor of floor plan ◯ 1010).” The context of component B 1020 would be: “@+(repository path of embedding anchor of floor plan ◯ 1010).”

The embedding context may be part of the change transaction and a change transaction with an embedding context may only be merged if the context is equal to the current context of the user interface request. That means the context should remain stable over different software releases, which may be ensured via stable anchors. If any user interface component which is part of this context chain is to be changed, the system may move the embedding anchor to a new target and the context depending personalization of the embedded component may be applied again. With this functionality, it may be possible to exchange for example floor plan ◯ 1010 with a new one and to move the embedding anchor from floor plan ◯ 1010 to the new floor plan. Note that the context of component B 1020 and component A 1030 will remain the same.

Note that in some cases, parts of a context chain may be added or deleted. For this reason, a system may offer an attribute of the stable anchor “embedded context” where the context may be set manually. For example, consider a component A embedded within component B and component B is embedded within component C. Moreover, component B will be deleted and the embedded context of a floor plan will be set to the context “@+(repository path of embedding anchor of component B)+@+(repository path of embedding anchor of floor plan ◯)” which was the original context of component B. This might be done, for example, by a user interface design tool automatically.

As another example, component A may be embedded in a floor plan ◯, and component B is to be inserted between component A and floor plan ◯. In this case, after the insertion component A will be embedded with in component B and component B will be embedded within floor plan ◯. Before the insertion, the context of component A was “@+(repository path of embedding anchor of floor plan ◯).” After the insertion, the context will be “@+(repository path of embedding anchor of floor plan ◯)” which is the same context of floor plan ◯. This may also be done automatically by a user interface design tool.

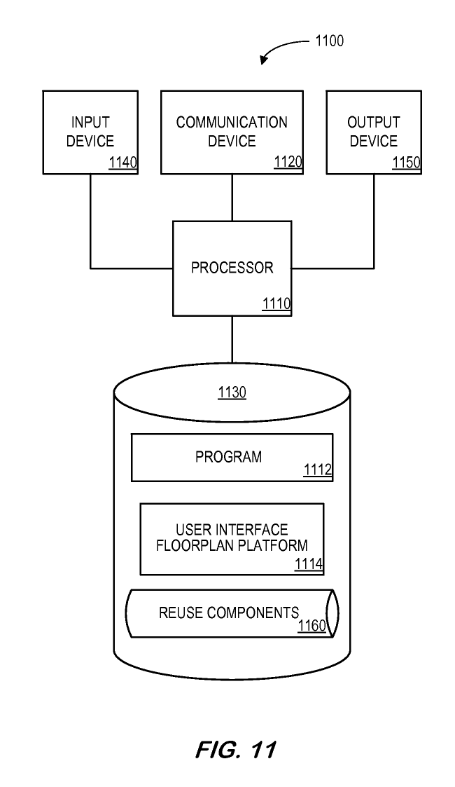

The processes described herein may be performed by any suitable device or apparatus. FIG. 11 is one example of a platform 1100 according to some embodiments. The platform 1100 may be, for example, associated with some or all of the elements described in connection with system 100 of FIG. 1 and system 900 of FIG. 9. The platform 1100 comprises a processor 1110, such as one or more commercially available Central Processing Units (CPUs) in the form of one-chip microprocessors, coupled to a communication device 1120 configured to communicate via a communication network (not shown in FIG. 11). The communication device 1120 may be used to communicate, for example, with one or more remote client devices. The platform 1100 further includes an input device 1140 (e.g., a mouse and/or keyboard to enter component parameters and/or rules) and an output device 1150 (e.g., a computer monitor to display reports and/or tables to an administrator).

The processor 1110 also communicates with a storage device 1130. The storage device 1130 may comprise any appropriate information storage device, including combinations of magnetic storage devices (e.g., a hard disk drive), optical storage devices, and/or semiconductor memory devices. The storage device 1130 stores a program 1112 and/or user interface floor plan platform 1114 for controlling the processor 1110. The processor 1110 performs instructions of the programs 1112, 1114, and thereby operates in accordance with any of the embodiments described herein. For example, the processor 1110 may associate a user interface floor plan with a plurality of reuse components, each reuse component being adapted to be used with a plurality of user interface floor plans, wherein a second reuse component is embedded within a first reuse component. The processor 1110 may also receive an end user adaptation to the second reuse component and automatically store, within the first reuse component, a context dependent reference to the second reuse component associated with the end user adaptation.

The programs 1112, 1114 may be stored in a compressed, uncompiled and/or encrypted format. The programs 1112, 1114 may furthermore include other program elements, such as an operating system, a database management system, and/or device drivers used by the processor 1110 to interface with peripheral devices. As used herein, information may be “received” by or “transmitted” to, for example: (i) the platform 1100 from another device; or (ii) a software application or module within the platform 1100 from another software application, module, or any other source.

In some embodiments (such as shown in FIG. 11), the storage device 1130 stores a reuse component database 800. The reuse component database 800 may, for example, comprise a database that contains context dependent personalization of reuse components associated with business platforms. Note that the databases mentioned herein are only examples, and additional and/or different information may be stored therein. Moreover, various databases might be split or combined in accordance with any of the embodiments described herein.

The embodiments described herein are solely for the purpose of illustration. Those in the art will recognize other embodiments may be practiced with modifications and alterations limited only by the claims.

What is claimed is:

1. A computer implemented method, comprising:
associating a user interface floor plan with a plurality of reuse components, each reuse component being adapted to be used with a plurality of user interface floor plans, wherein a second reuse component is embedded within a first reuse component;
receiving an end user adaptation to the second reuse component; and
automatically storing, within the first reuse component, a context dependent reference to the second reuse component associated with the end user adaptation.

2. The method of claim 1, further comprising:
determining that the first reuse component is to be switched to a new reuse component; and
automatically copying the reference from the first reuse component to the new reuse component.

3. The method of claim 1, wherein the first reuse component is embedded within the user interface floor plan and further comprising:
determining that the first reuse component is to be deleted; and
automatically copying the reference from the first reuse component to use interface floor plan.

4. The method of claim 1, further comprising:
determining that a new reuse component is to be inserted between the first and second reuse components; and
automatically moving the reference from the first reuse component to the new reuse component.

5. The method of claim 1, wherein the reference comprises a component identifier and file path.

6. The method of claim 5, wherein the reference comprises a stable embedding anchor.

7. The method of claim 6, wherein the embedding anchor includes a reference to a software version number.

8. The method of claim 6, wherein the file path comprises a chain of file paths associated with a plurality of embedding anchors associated with embedded reuse components.

9. The method of claim 1, wherein the first and second reuse components are associated with a component repository maintained at a business service provider backend system.

10. A non-transitory computer-readable medium storing program code executable by a computer to perform a method, the method comprising:
associating a user interface floor plan with a plurality of reuse components, each reuse component being adapted to be used with a plurality of user interface floor plans, wherein a second reuse component is embedded within a first reuse component;
receiving an end user adaptation to the second reuse component; and
automatically storing, within the first reuse component, a context dependent reference to the second reuse component associated with the end user adaptation.

11. The medium of claim 10, wherein the method further comprises:
determining that the first reuse component is to be switched to a new reuse component; and
automatically copying the reference from the first reuse component to the new reuse component.

12. The medium of claim 10, wherein the first reuse component is embedded within the user interface floor plan and further comprising:
determining that the first reuse component is to be deleted; and
copying the reference from the first reuse component to use interface floor plan.

13. The medium of claim 10, further comprising:
determining that a new reuse component is to be inserted between the first and second reuse components; and
moving the reference from the first reuse component to the new reuse component.

14. The medium of claim 1, wherein the reference comprises a component identifier and file path.

15. The medium of claim 5, wherein the reference comprises a stable embedding anchor including a reference to a software version number.

16. A system, comprising:
a data store containing a plurality of reuse components adapted to be used with a plurality of user interface floor plan; and
an enterprise service infrastructure backend adapted to support a client device and to:
associate a user interface floor plan with a plurality of reuse components, wherein a second reuse component is embedded within a first reuse component;
receive an end user adaptation to the second reuse component; and
automatically store, within the first reuse component, a context dependent reference to the second reuse component associated with the end user adaptation.

17. The system of claim 16, wherein the enterprise service infrastructure backend is further to:
determine that the first reuse component is to be switched to a new reuse component; and
automatically copy the reference from the first reuse component to the new reuse component.

18. The system of claim 16, wherein the first reuse component is embedded within the user interface floor plan and the enterprise service infrastructure backend is further to:
determine that the first reuse component is to be deleted; and
automatically copy the reference from the first reuse component to use interface floor plan.

19. The system of claim 16, wherein the enterprise service infrastructure backend is further to:
determine that a new reuse component is to be inserted between the first and second reuse components; and
automatically move the reference from the first reuse component to the new reuse component.

20. The system of claim 16, wherein the reference comprises a stable embedding anchor including a reference to a software version number
